(19) United States
(12) Patent Application Publication
(10) Pub. No.: US 2009/0174805 A1
(43) Pub. Date: Jul. 9, 2009

(54) DIGITAL CAMERA FOCUSING USING STORED OBJECT RECOGNITION

(75) Inventors: William P. Alberth, JR., Prairie Grove, IL (US); Dean E. Thorson, Grayslake, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/970,039

(22) Filed: Jan. 7, 2008

(51) Int. Cl. H04N 5/232

(52) U.S. Cl. 348/345; 348/E05.042

(57) ABSTRACT

A technique for focusing a digital camera is described that includes pre-storing 200 at least one specific image object, such as a known face or landmark, activating 202 the camera to obtain an image, analyzing 204 objects in the image, comparing 206 the objects in the image against the at least one specific image object, and determining 208 if there is a match between at least one object in the image and at least one specific image object. If a match is found, the camera is focused 212, 214, 216, 218 on the matched object and the image is captured 220.

### TECHNICAL FIELD OF THE INVENTION

This invention relates generally to automatic focusing of a digital camera, and in particular to automatic focusing of a digital camera using a recognized stored object.

### BACKGROUND OF THE INVENTION

Digital cameras have found wide use in an ever expanding range of devices other than stand-alone cameras. Such devices include mobile or fixed wireless communications devices, video cameras, computer attachments, and the like, for example. In addition, these many digital camera devices find use in a widely varying range of applications. These applications can include simple applications such as taking casual pictures of friends and family, or complicated applications such as security monitors with facial recognition. In most cases, the operators of such cameras are not professional or even skilled photographers, and therefore these users welcome any assistance that can be provided to capture accurate images in a fast and simple way. Accordingly, the makers of digital cameras have introduced various types of automation into their cameras to assist users.

Auto-focusing technology is one type of automation used for digital cameras that comprises a long-standing area of endeavor. For example, systems have been introduced in digital cameras to provide auto-focusing on human faces, which is the most typical subject to photograph. Using sophisticated algorithms, auto-focusing can detect certain typical and general attributes of a human faces, and focus on those attributes using edge-detection, high-frequency content detection, or other known focusing techniques. In addition, for video systems such as airport security cameras, people may be moving in and out of focus all the time, and it is important that these cameras systems provide a good focusing system to accurately capture faces for later comparison to a database of known people.

In either of these scenarios, it is desirable to have a digital camera that focuses on a selected human face or object in the image rather than other surrounding objects. However, when there are many people in the frame of the image, the prior art provides no means to single out any one person or object to use for focusing over the other surrounding people.

What is needed is a focusing technique in a digital camera that allows the camera to focus on a specific person or object in a frame of a picture. It would also be of benefit to provide a method and system to accomplish this automatic focusing in a simple, fast and accurate way to achieve a desired result.

### BRIEF DESCRIPTION OF THE DRAWINGS

The above needs are met through provision of the method and apparatus described in the following detailed description, particularly when studied in conjunction with the drawings, wherein:

FIG. 1 comprises a simplified block diagram of a digital camera apparatus, in accordance with the present invention; and

FIG. 2 comprises a flow diagram of a method, in accordance with the present invention.

Skilled artisans will appreciate that elements in the figures are illustrated for simplicity and clarity and that common but well-understood elements that are useful or necessary in a commercially feasible embodiment are typically not depicted in order to facilitate a less obstructed view of these various embodiments of the present invention.

### DETAILED DESCRIPTION OF THE INVENTION

Generally speaking, pursuant to these various embodiments, the present invention provides an automatic focusing technique in a digital camera that allows the camera to focus on a specific person(s) or object(s) in a frame of a picture. This is accomplished in a simple, fast and accurate way in order to achieve a desired result.

The present invention as described herein uses the example of focusing on a human face. However, it should be recognized that the present invention is equally applicable to focusing on any image object, such as a landmark and the like, or even only a particular attribute of an image object, such as a portion of the image having a particular shape or color for example.

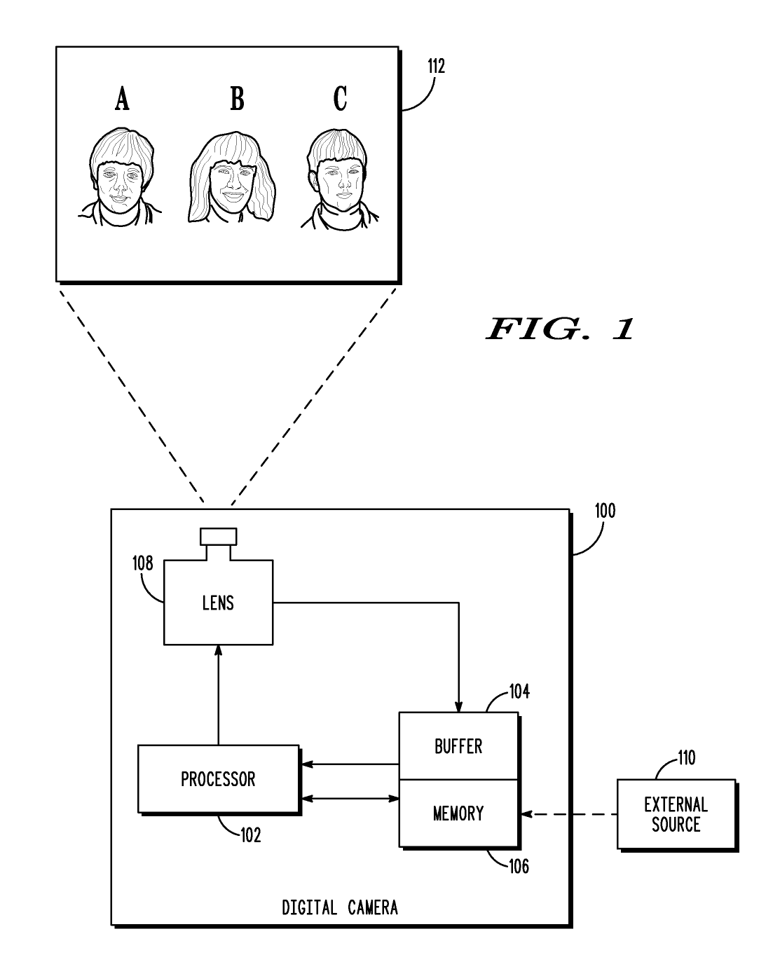

Referring to FIG. 1, a digital camera apparatus 100 is shown in accordance with the present invention. The digital camera 100 includes a processor 102, an image capture device 104, a memory 106, and a lens device 108. It should be recognized that there are many other known devices within a digital camera that are not shown for the sake of simplicity. The processor serves to facilitate many of the various actions described herein. This processor 102 can comprise an integrated platform or can be distributed over a plurality of physically separated processing mechanisms, with both architectural approaches being generally well understood in the art. If desired, the processor 102 can comprise, in whole or in part, a dedicated platform comprised of essentially hard-wired processes and responses. In a preferred embodiment, however, the processor 102 comprises a programmable platform and may include one or more microprocessors, microcontrollers, digital signal processors, and the like.

The processor 102 may have sufficient native memory to facilitate its various actions and/or it may be optionally operably coupled to additional memory 104, 106 as shown. As appropriate to a given application, this additional memory 104, 106 can be physically co-located with the processor 102 or can be located physically remote therefrom.

The image capture device functions with the lens device 108 that can include a charge coupled device (not shown) to temporarily capture an image. The image capture device can be either a still image capture device or a video image capture device. The image capture device in a preferred embodiment operates under the control of the processor 102 but may, if desired, provide a constant stream of capture image information in an open-loop fashion or in response to an alternative control mechanism (not shown) such as an independent trigger device. If desired, the image capture device(s) may be remotely controllable such that the camera can be aimed in a preferred direction in a controlled fashion and/or to permit zoom capabilities or other selectable features (such as exposure, focusing, or contrast) to be used in response to remote signaling (from, for example, the processor 102).

In general, the image capture device is positioned and configured to permit capturing images of a person (either images featuring the entire person or pertinent portions thereof). In particular, the image capture device is preferably oriented to permit capturing images of a person's face (such an image can be a full front view, a full profile view, a perspective view, and so forth as desired). Such facial images are usable by the processor 102 to facilitate automatic focusing as noted below in more detail.

Typically the image capture device includes a buffer 104 that can be a separate device, part of the CCD, or part of the memory 106. The buffer is coupled to the processor 102, which can analyze the image in the buffer to adjust picture quality characteristics, such as speed, exposure, and the like, as is known in the art, before capturing the image 112 in the memory 106. Optionally, it may be necessary to pre-focus the camera to obtain recognizable faces in the first place. This can be accomplished by having the focusing lens always drive to a first fixed focus point (e.g. infinity) before attempting to take a picture, or to drive the focusing lens to pre-focus the image using generalized objects in the image, as is known in the art.

In accordance with the present invention, the memory 106 is operable to pre-store at least one specific image object, as selected by a user. For example, users may be most interested in properly focusing the camera onto faces of their children (as used herein as an example), family members, or friends. Accordingly, these users can store signatures of each of their children‘s’ faces in the memory as image objects for later comparison, as will be detailed below in a preferred embodiment. Alternatively, the actual images of their children‘s’ faces could be stored in the memory as image objects for later comparison. However, this would consume more space in the memory and require more advanced processing power for later comparison to an actual image. In either case, the desired image object is provided from an external source 110 or is converted from an image captured in the camera 100 by the processor 102 for storage in the memory 106 as an image object.

Ideally, it is desired to store an object representing only the image desired, e.g. have the face of a child on a plain, indistinct background. Although, this could be done in this example this is not practical when trying to store an image of a landmark, which may not be separable from background objects. Therefore, it is preferred to isolate the desired object in a picture to better define an image object for storage. This can be accomplished by digitally highlighting only the desired area of a photograph, and cropping to this highlighted area to remove the background as much as possible, and storing only the highlighted area containing the desired image object or deriving a signature defining the highlighted image region.

A signature is an image object that distills pre-defined attributes of an image into a unique digital identification, as is known in the art. For example, a human face can be identified by eye, nose, ear, brow, and mouth configuration, skin tone, distance and arrangement between features, etc. A list of these attributes are then codified into a digital signature of that face describing each of these attributes, which can then be stored into memory as an image object.

In operation, the image capture device (buffer 104 in conjunction with lens 108) is operable to obtain an image 112 when activated. The processor 102 is coupled to the memory 106 and buffer 104 and is operable to analyze objects in the image stored in the buffer 104. This analysis can include recognizing that there are faces (A, B, C) in the image 112, using known techniques in face recognition. For example, the processor can use known physical feature analysis tools to recognize that there are eyes in the image 112 or use color analysis tools to recognize that there are regions of color in the image having a known skin tone or hair tone color spectrum. In this way the processor can tag regions in the image that should contain faces that can be used for later comparison. Alternatively, the processor can use a brute force technique to parse the image into blocks and scan each block for a match to a pre-stored face.

Once the processor has identified and tagged the faces it has found in the image, the processor can then distill the attributes of each of these faces into a digital signature of that face to define image objects as was previously done for the pre-stored image objects described above. If actual images were previously pre-stored for comparison, then the processor uses the tagged image regions of the image as image objects.

The processor 102 then compares the tagged objects in the image against the at least one specific pre-stored image object, and determines if there is a match between the at least one object in the image and at least one specific pre-stored image object. In particular, the processor compares the pre-stored signature(s) against the signature(s) determined for the faces (A, B, C) in the image. This comparison can be a simple mathematical comparison that provides a difference (error) between the two digital signatures. If the difference is less than a predetermined threshold, then the processor can assume that the compared face (A, B, C) in the image is a face matching a desired face stored in the memory. Of course there many techniques known in the art, including probability techniques, by which such matching can be effected, but will not be presented here for the sake of brevity.

If the processor 102 finds that there is a match, the processor drives the focusing lens 108 to focus the image 112 on the matched object. For example, if face B is a face of one of the user's children that had been pre-stored in the memory, and if the processor is able to find a sufficient match therebetween, then the processor will drive the focusing lens 108 to focus the image 112 on face B.

At this point the processor 102 can capture the focused image in the buffer by transferring the focused image to the memory 106 for storage. The scenario above was described in terms of finding one matching face. However, the present invention envisions different scenarios for the cases for finding no match, or several matches. Of course, if no matches are found the camera can focus the image 112 using any previously known technique, such as focusing at infinity, edge detection, or focusing the lens to maximize high frequency content in the buffer. However, if there are multiple matches found, then several options present themselves.

In a first option, if multiple faces are matched (e.g. A and B), the processor 102 can drive the focusing lens 108 to focus on each matched object A and B in turn followed by the processor 102 directing the image capture device 108, 104, 106 to capture each focused image as two separate pictures. The two separate images can be combined at the time the pictures are taken or later in time with techniques that are known in the art.

In a second option, if multiple faces are matched (e.g. A and B), the processor 102 can drive the focusing lens to focus on objects A and B as a group, followed by the processor 102 directing the image capture device 108, 104, 106 to capture the image as one picture. This can be accomplished by taking an average or weighted average of the focus metrics of images of face A and B, or by focusing the image such that the signatures of face A and B both match their corresponding pre-stored signatures to above a certain threshold.

In a third option, if multiple faces are matched (e.g. A and B), the processor 102 can direct a user to select which of the matched objects to focus on, wherein the processor directs the focusing lens to focus on the selected object, and directs the image capture device to capture that focused image. For example, the processor can identify the tagged faces on a graphical user interface of the camera (e.g. LCD screen highlight not shown), and the user can select which tagged face to focus on using a cursor, range button, touch screen, and the like, wherein the processor takes the user input to identify the selected tagged face to focus the image.

It should be clearly understood that the above-described embodiments are intended to be illustrative only. In fact, numerous other configurations and/or components will readily serve to realize these same teachings. Further, these same teachings can be applied to numerous other applications mentioned above or in addition thereto. For example, the present invention can be applied to a video security checkpoint. When subjects pass through a monitored checkpoint, such as an airport queue for example, their faces can be compared with a faces from a pre-existing external database 110 of individuals of interest and focused upon and captured when there is a match of signatures.

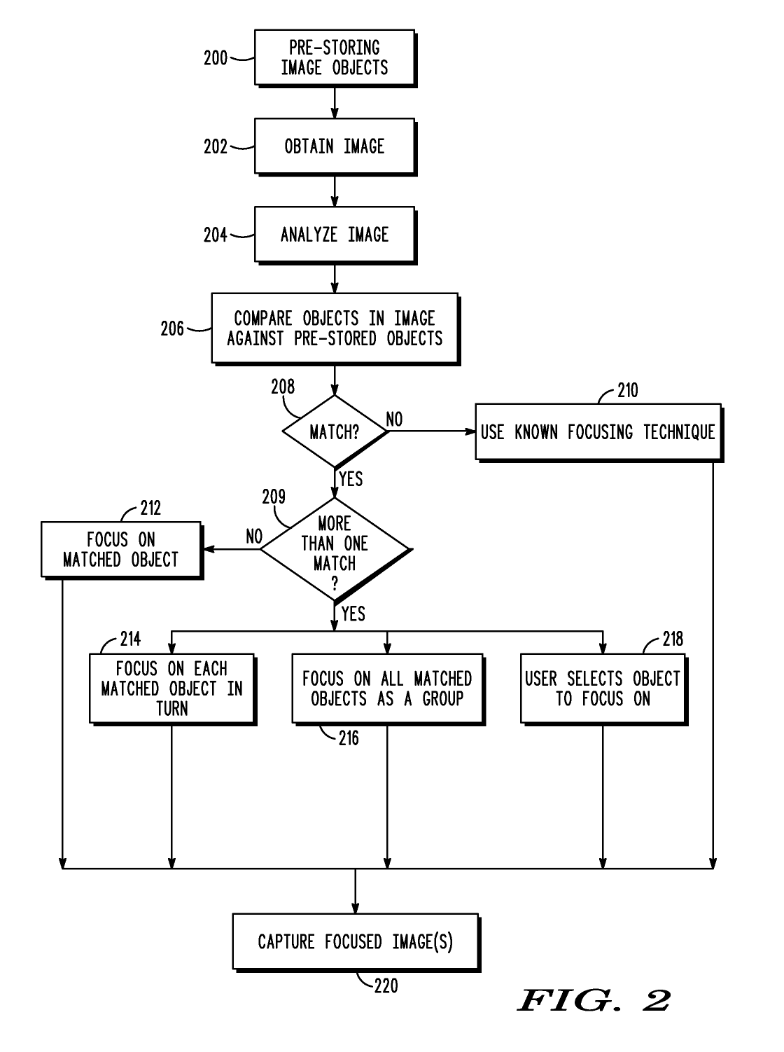

Referring to FIG. 2, the present invention also provides a method for automatically focusing a digital camera.

A first step 200 includes pre-storing at least one specific image object. This image object can be a specifically known human face, a landmark, or any other known object that a user would desire to focus upon. For example, users could store images of their children, such that whenever one or more of these children are in a frame of a picture, the digital camera will automatically focus upon these children's faces to the exclusion of other objects in the picture. Preferably, the image object is a digital signature describing attributes of the face or landmark.

A next step 202 includes activating the camera to obtain an image. It may be necessary in this step to include a substep of pre-focusing the image in order to first obtain a workable image.

A next step 204 includes analyzing the objects in the image. Such analyzing can include any or all of the substeps of recognizing a face, obtaining a digital signature of the face, and tagging the faces in the image. For example, an analysis may recognize objects in the image as human faces in two regions of the image, wherein these regions may be reduced to a digital signature and tagged as region A and region B for comparison against the pre-stored image objects.

A next step 206 includes comparing the tagged objects in the image against the at least one specific pre-stored object.

A next step 208 includes determining if there is a match between at least one tagged object in the image and at least one of the specific pre-stored objects. If there is no match, then the image can be focused 210 using any previously known focusing technique.

If there is one match 209, a next step 212 includes focusing the image on the matched object. If there is more than one match 209 several options present themselves. In a first option, if there is more than one match 209 from the determining step 208, the focusing step 214 focuses on each matched face in turn and the capturing step 220 captures each focused image. In a second option, if there is more than one match 209 from the determining step 208, the focusing step 216 focuses on all the matched faces as a group (taken as an average for example). In a third option, if there is more than one match 209 from the determining step 208, a further substep is introduced to have a user select (through a graphical user interface for example) which of the matched faces to focus on, wherein the focusing step 218 focuses on the selected face.

A final step 220 includes capturing the focused image(s).

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for focusing a digital camera, comprising:
pre-storing at least one specific image object;
activating the camera to obtain an image;
analyzing objects in the image;
comparing the objects in the image against the at least one specific image object;
determining if there is a match between at least one object in the image and at least one specific image object, wherein if there if a match; and
focusing the image on the matched object.

2. The method of claim 1, wherein if there is more than one match in the determining step, the focusing step focuses on each matched object in turn followed by the further step of capturing each focused image.

3. The method of claim 1, wherein if there is more than one match in the determining step, the focusing step focuses on all the matched objects as a group, followed by the further step of capturing that focused image.

4. The method of claim 1, wherein if there is more than one match in the determining step, further comprising the step of a user selecting which of the matched objects to focus on, wherein the focusing step focuses on the selected object, followed by the further step of capturing that focused image.

5. The method of claim 1, wherein the analyzing step includes obtaining a signature and tagging objects in the image for comparison.

6. The method of claim 1, wherein the pre-storing step includes specific landmarks.

7. The method of claim 1, wherein the pre-storing step includes specific human faces.

8. The method of claim 1, wherein the activating step includes pre-focusing the image using generalized objects in the image.

9. A method for focusing a digital camera, comprising:
pre-storing a signature of at least one specific human face;
activating the camera to obtain an image;
obtaining a signature and tagging human faces in the image;
comparing the signature of the tagged human faces in the image against the signature of the at least one pre-stored specific human face;
determining if there is a match between the signatures, wherein if there if a match;
focusing the image on the matched human face; and
capturing the focused image.

10. The method of claim 9, wherein if there is more than one match in the determining step, the focusing step focuses on each matched face in turn and the capturing step captures each focused image.

11. The method of claim 9, wherein if there is more than one match in the determining step, the focusing step focuses on all the matched faces as a group.

12. The method of claim 9, wherein if there is more than one match in the determining step, further comprising the step of a user selecting which of the matched faces to focus on, wherein the focusing step focuses on the selected face.

13. The method of claim 9, wherein the activating step includes pre-focusing the image using generalized objects in the image.

14. A digital camera apparatus comprising:
a memory that is operable to pre-store at least one specific image object, as selected by a user;
an image capture device that is operable to obtain an image when activated; and
a processor coupled to the memory and image capture device, the processor operable to analyze objects in the image, compare the objects in the image against the at least one specific image object, and determine if there is a match between at least one object in the image and at least one specific image object; and
a focusing lens controlled by the processor, wherein if the processor finds that there if a match, the processor drives the focusing lens to focus the image on the matched object.

15. The apparatus of claim 14, wherein if the processor finds more than one match, the processor drives the focusing lens to focus on each matched object in turn followed by the processor directing the image capture device to capture each focused image.

16. The apparatus of claim 14, wherein if the processor finds more than one match, the processor drives the focusing lens to focus on all the matched objects as a group, followed by the processor directing the image capture device to capture that focused image.

17. The apparatus of claim 14, wherein if the processor finds more than one match, the processor directs a user to select which of the matched objects to focus on, wherein the processor directs the focusing lens to focus on the selected object, and directs the image capture device to capture that focused image.

18. The apparatus of claim 14, wherein the processor obtains a signature and tags objects in the image for comparison.

19. The apparatus of claim 14, wherein the processor drives the focusing lens to pre-focus the image using generalized objects in the image.
